(19) United States
(12) Patent Application Publication
(10) Pub. No.: US 2025/0367784 A1
(43) Pub. Date: Dec. 4, 2025

(54) ABRASIVE ARTICLES, SYSTEMS AND METHODS OF USE

(71) Applicant: 3M INNOVATIVE PROPERTIES COMPANY, St. Paul, MN (US)

(72) Inventors: Joseph B. Eckel, Vadnais Heights, MN (US); Ernest L. Thurber, Somerset, WI (US); Yuyang Liu, St. Paul, MN (US); Junting Li, Shanghai (CN); Jing Zhang, Minneapolis, MN (US); Michelle L. Conklin, Landenberg, PA (US); Thomas J. Nelson, Woodbury, MN (US); Ann Marie Hawkins, Lake Elmo, MN (US); Gregory P. Sorenson, Maplewood, MN (US); Paul Larking, Staffordshire (GB); Theo L. Simon, Warwickshire (GB); David T. Buckley, Falcon Heights, MN (US)

(21) Appl. No.: 18/874,138

(22) PCT Filed: Jun. 16, 2023
(86) PCT No.: PCT/IB2023/056277

§ 371 Date: Dec. 12, 2024

Related U.S. Application Data
(60) Provisional application No. 63/366,802, filed on Jun. 22, 2022.

(51) Int. Cl. B24B 49/16; B24B 49/00; B24B 49/12; B24B 49/14

(52) U.S. Cl. CPC B24B 49/16; B24B 49/006; B24B 49/12; B24B 49/14

(57) ABSTRACT

An abrasive article evaluation system includes a detector that detects an abrasive wear cue. The system also includes an efficiency indication generator that, based on the abrasive wear cue, generates an indication of wear for the abrasive article. The system also includes a command generator that generates a command based in the generated indication of wear.

### BACKGROUND

Coated abrasive articles containing shaped abrasive grains are useful for shaping, finishing, or grinding a wide variety of materials and surfaces such as wood, metals (e.g., especially non-ferrous metals such as aluminum that tend to clog grinding wheels), and flash. There continues to be a need for improving the cost, performance, and/or life of coated abrasive articles.

### SUMMARY

An abrasive article evaluation system includes a detector that detects an abrasive wear cue. The system also includes an efficiency indication generator that, based on the abrasive wear cue, generates an indication of wear for the abrasive article. The system also includes a command generator that generates a command based in the generated indication of wear.

A robotic abrading system is presented that includes an abrasive article including a wear cue. The system also includes a backup pad coupled to the abrasive article. The system also includes a robot arm configured to move the abrasive article into position with respect to a substrate. The system also includes a force control unit, on the robot arm and coupled to the backup pad. The force control unit applies a force to the backup pad. The system also includes a wear indication system that determines an amount of wear of the abrasive article based on the wear cue, and, based on the amount of wear, an operational parameter of the robotic abrading system is adjusted.

Described herein are systems and methods for detecting when an abrasive article is nearing the end of its useful life. Some systems and methods herein may improve efficiency of use of abrasive articles as abrasive particles are worn down. However, systems and methods herein are not limited to measuring wear of abrasive particles. It may also be useful to detect wear of a resin matrix, for example in a nonwoven or bonded abrasive article where the entire article wears down during use. Some abrasive articles experience wear of particles and resin down to a backing layer, providing opportunities to visually detect changes.

Some systems and methods herein may be particularly useful for robotic abrading systems, where a human operator is not available to detect the end of life by noticing the change in abrading efficiency. Additionally, some systems and methods herein may be useful for handheld abrasive tools to assist an operator in adjusting use parameters for a tool during an abrading operation.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### BRIEF DESCRIPTION OF THE DRAWINGS

FIG. 1 is a top-down schematic of an exemplary coated abrasive article.

FIG. 2 is a schematic cross-sectional view of an exemplary coated abrasive article.

FIG. 3 illustrates a robotic abrading system that may benefit from embodiments herein.

FIG. 4 illustrates a hand held abrading system that may benefit from embodiments herein.

FIG. 5 illustrates an abrasive article evaluation system in accordance with embodiments herein.

FIG. 6 illustrates a method of abrading an abrasive article in accordance with embodiments herein.

FIGS. 7A-7F illustrate nonwoven fibers that may be used in embodiments herein.

FIG. 8 illustrates an abrasive belt in accordance with embodiments herein.

FIG. 9 illustrates an abrasive article in accordance with embodiments herein.

FIG. 10 illustrates a method of detecting a wear indicator in an abrasive article in accordance with embodiments herein.

FIGS. 11A-11B illustrate produced swarf in accordance with embodiments herein.

FIGS. 12A-12B illustrate material removal rate and temperature over cycle.

FIG. 13 is a defect inspection system architecture.

FIGS. 14-16 show examples of computing devices that can be used in embodiments shown in previous Figures.

FIG. 17 illustrates an example interface for a grinding machine that may be used in embodiments here.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting: information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “shaped abrasive particle,” means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation. Suitable examples for geometric shapes having at least one vertex include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example super elliptical shapes).

For the purposes of this invention, geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate. The second side may include (and preferably is) a second face. The second face may have a perimeter of a second geometric shape.

For the purposes of this invention, shaped abrasive particles also include abrasive particles comprising faces with different shapes, for example on different faces of the abrasive particle. Some embodiments include shaped abrasive particles with different shaped opposing sides. The different shapes may include, for example, differences in surface area of two opposing sides, or different polygonal shapes of two opposing sides.

The shaped abrasive particles are typically selected to have an edge length in a range of from 0.001 mm to 26 mm, more typically 0.1 mm to 10 mm, and more typically 0.5 mm to 5 mm, although other lengths may also be used.

The shaped abrasive particle may have a “sharp portion” which is used herein to describe either a sharp tip or a sharp edge of an abrasive article. The sharp portion may be defined using a radius of curvature, which is understood in this disclosure, for a sharp point, to be the radius of a circular arc which best approximates the curve at that point. For a sharp edge, the radius of curvature is understood to be the radius of the curvature of the profile of the edge on the plane perpendicular to the tangent direction of the edge. Further, the radius of curvature is the radius of a circle which best fits a normal section, or an average of sections measured, along the length of the sharp edge. The smaller a radius of curvature, the sharper the sharp portion of the abrasive particle. Shaped abrasive particles with sharp portions are defined in U.S. Provisional Patent Application Ser. No. 62/877,443, filed on Jul. 23, 2019, which is hereby incorporated by reference.

In the instance that the abrasive particles are precisely-shaped (e.g., into triangular platelets or conical particles), this effect of orientation can be especially important as discussed in U. S. Pat. Appl. Publ. No. 2013/0344786 A1 (Keipert), incorporated by reference herein. As used herein, the term “alignment” is used to refer to a relative position of an abrasive particle on a backing, while the term “orientation” refers to a rotational position of the abrasive particle at the aligned position. For example, a triangle-shaped particle may have a “tip up” orientation or a “tip down” orientation with respect to the backing.

As used herein, the term shaped abrasive particle refers to a monolithic abrasive particle. As shown, shaped abrasive particle is free of a binder and is not an agglomeration of abrasive particles held together by a binder or other adhesive material.

Described in embodiments here are abrasive articles that include wear indicators or other abrasive efficiency indicators. Some example embodiments are described in the context of particular abrasive article types, such as bonded abrasive wheels or a coated fiber disc. However, it is expressly contemplated that at least some efficiency indicators herein are applicable to multiple types of abrasive articles, and the figures and examples described herein are not intended to be limited.

Additionally, with respect to coated abrasive articles, many examples herein discuss abrasive discs specifically. However, it is expressly contemplated that abrasive belts may also benefit from efficacy indicators described herein.

Further, with respect to bonded abrasive articles, some examples of grinding wheels are described herein. However, it is expressly contemplated that wear indicators suitable for some grinding articles may be suitable for others. Bonded abrasive articles may use vitreous, resin or polymer-based bond matrices. Bonded abrasive structures may include depressed center grinding wheels, cut off wheels, cut-and-grind wheels, precision bonded wheels, cup wheels, segmented grinding wheels, etc. . . .

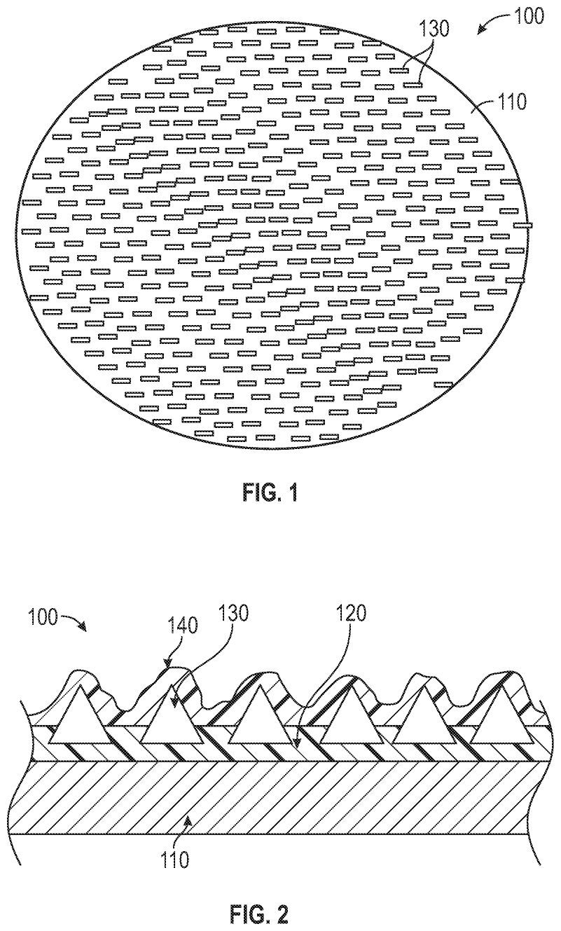

FIGS. 1 and 2 show an exemplary coated abrasive disc 100 according to the present disclosure, wherein shaped abrasive particles 130 are secured at precise locations and Z-axis rotational orientations to a backing 110. In one embodiment, shaped abrasive particles 130 are triangular prism shaped particles that appear rectangular when viewed from above.

Generally, a coated abrasive article 100 includes a plurality of abrasive particles at least partially embedded within a make coat that secures the particles to a backing. The backing may be formed from any known flexible coated abrasive backing, for example. Suitable materials for the backing include polymeric films, metal foils, woven fabrics, knitted fabrics, paper, nonwovens, foams, screens, laminates, combinations thereof, and treated versions thereof.

The abrasive particles 130 may be embedded within an abrasive layer, which can include multilayer construction having make 120 and size layers 140. Coated abrasive articles according to the present disclosure may include additional layers such as, for example, an optional supersize layer that is superimposed on the abrasive layer, or a backing antistatic treatment layer may also be included, if desired. Exemplary suitable binders can be prepared from thermally curable resins, radiation-curable resins, and combinations thereof.

Make layer 120 can be formed by coating a curable make layer precursor onto a major surface of backing 110. The make layer precursor may include, for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant α,β-unsaturated groups, acrylated urethane, acrylated epoxy, acrylated isocyanurate), epoxy resin (including bis-maleimide and fluorene-modified epoxy resins), isocyanurate resin, and mixtures thereof. Of these, phenolic resins are preferred.

Phenolic resins are generally formed by condensation of phenol and formaldehyde, and are usually categorized as resole or novolac phenolic resins. Novolac phenolic resins are acid-catalyzed and have a molar ratio of formaldehyde to phenol of less than 1:1. Resole (also resol) phenolic resins can be catalyzed by alkaline catalysts, and the molar ratio of formaldehyde to phenol is greater than or equal to one, typically between 1.0 and 3.0, thus presenting pendant methylol groups. Alkaline catalysts suitable for catalyzing the reaction between aldehyde and phenolic components of resole phenolic resins include sodium hydroxide, barium hydroxide, potassium hydroxide, calcium hydroxide, organic amines, and sodium carbonate, all as solutions of the catalyst dissolved in water.

Resole phenolic resins are typically coated as a solution with water and/or organic solvent (e.g., alcohol). Typically, the solution includes about 70 percent to about 85 percent solids by weight, although other concentrations may be used. If the solids content is very low, then more energy is required to remove the water and/or solvent. If the solids content is very high, then the viscosity of the resulting phenolic resin is too high which typically leads to processing problems.

Phenolic resins are well-known and readily available from commercial sources. Examples of commercially available resole phenolic resins useful in practice of the present disclosure include those marketed by Durez Corporation under the trade designation VARCUM (e.g., 29217, 29306, 29318, 29338, 29353): those marketed by Ashland Chemical Co. of Bartow, Florida under the trade designation AEROFENE (e.g., AEROFENE 295); and those marketed by Kangnam Chemical Company Ltd. of Seoul, South Korea under the trade designation PHENOLITE (e.g., PHENOLITE TD-2207).

The make layer precursor may be applied by any known coating method for applying a make layer to a backing such as, for example, including roll coating, extrusion die coating, curtain coating, knife coating, gravure coating, and spray coating.

The basis weight of the make layer utilized may depend, for example, on the intended use(s), type(s) of abrasive particles, and nature of the coated abrasive article being prepared, but typically will be in the range of from 1, 2, 5, 10, or 15 grams per square meter (gsm) to 20, 25, 100, 200, 300, 400, or even 600 gsm. The make layer may be applied by any known coating method for applying a make layer (e.g., a make coat) to a backing, including, for example, roll coating, extrusion die coating, curtain coating, knife coating, gravure coating, and spray coating.

Once the make layer precursor is coated on the backing, the triangular abrasive particles are applied to and at least partially embedded in the make layer precursor. The triangular abrasive particles are applied nominally according to a predetermined pattern and Z-axis rotational orientation onto the make layer precursor. Using known orientation methods, such as electrostatic or magnetic orientation, it is possible to orient the abrasive particles with respect to the backing in order to improve performance of the particles.

However, while FIGS. 1-2 illustrate a coated abrasive article, it is expressly contemplated that systems and methods herein may also be suitable for understanding use and wear of other abrasive articles such as bonded abrasive articles with resin or vitreous bond matrices, nonwoven abrasive articles, brushes, or other abrasive articles.

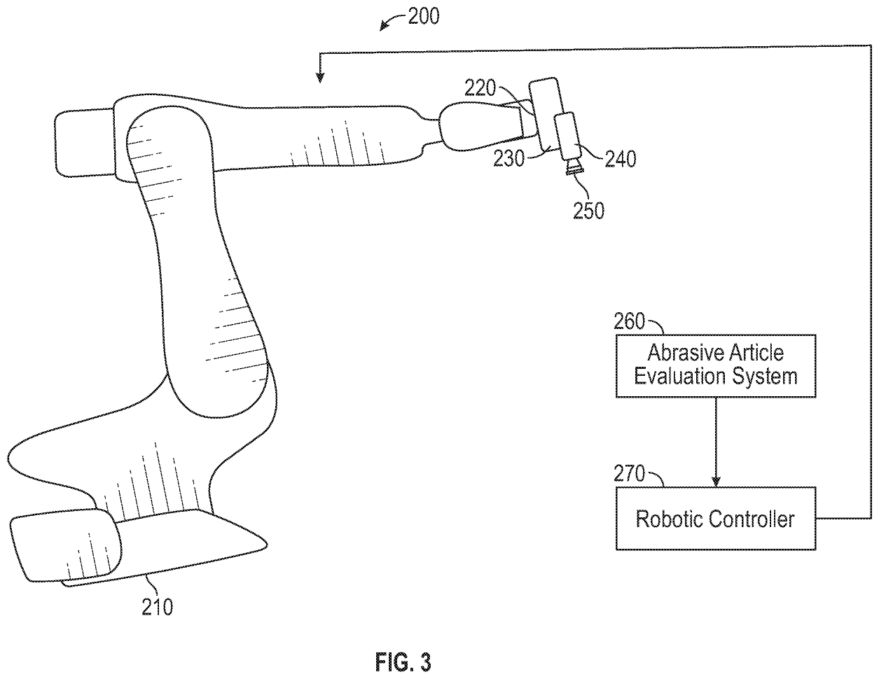

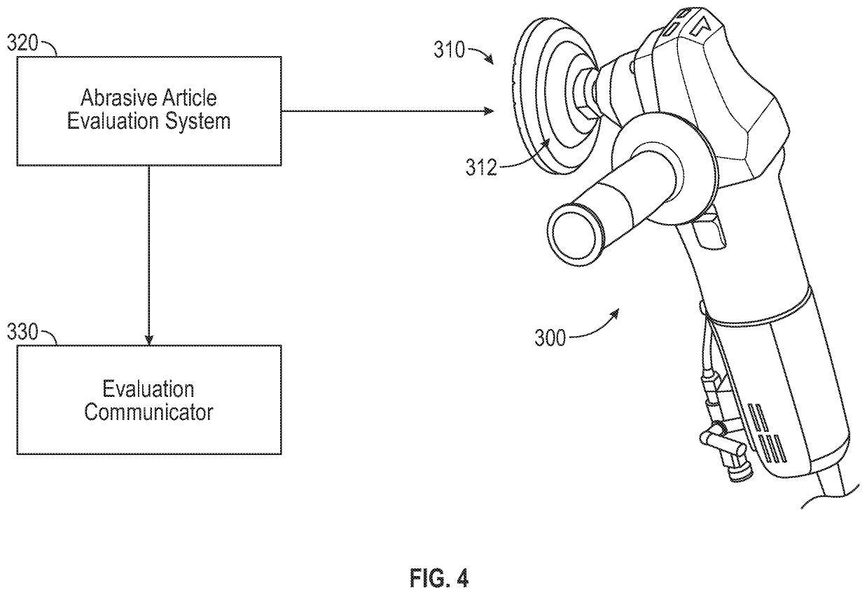

Abrasive articles may be used in a number of contexts. Described herein are the robotic repair context (FIG. 3) and the handheld tool context (FIG. 4). Different use scenarios of abrasive articles present different problems regarding article use over time. For example, an experienced human operator can often “feel” when an abrasive article is losing cut efficacy over time and adjust accordingly, by applying more force or adjusting an angle. A robotic system may have no insight into the wear or loading occurring on an abrasive article and may not make necessary adjustments or replace an abrasive article when needed. Systems and methods herein may be useful in other contexts as well.

FIG. 3 is a schematic of a robotic arm that may benefit from embodiments disclosed herein. A robotic repair unit 200 has a base 210, which may be stationary, in some embodiments. In other embodiments, base 210 can move in any of six dimensions, translations or rotations about an x-axis, y-axis and/or z-axis. For example, robot 200 may have a base 210 fixed to a rail system configured to travel along with a moving substrate being repaired. Depending on a particular operation, robot 200 may need to move closer, or further away from a substrate, or may need to move higher or lower with respect to an abrading area. A moveable base 200 may thus increase functionality.

Robotic arm unit 200 has one or more tools 240 that can interact with a worksurface. Tool 240 may include a backup pad 250, in one embodiment, or another suitable abrasive tool. During an abrasive operation, tool 240 may have an abrasive disc, or other suitable abrasive article, attached using adhesive, hook and loop, clip system, vacuum or other suitable attachment system. However, as the abrasive article moves in conjunction with a backup pad 250 to which it is attached, the abrasive article is not necessarily considered as adding additional degrees of freedom to the movement of robotic repair unit 200. As mounted to the robotic repair unit 200, tool 240 has the ability to be positioned within the provided degrees of freedom by the robotic repair unit 200 (6 degrees of freedom in most cases) and any other degrees of freedom (e.g., a compliant force control 230 unit).

Backup pad 250 is coupled to a tool 240 which has an orbit that provides some additional degrees of freedom. In most tools a single degree of freedom is provided by a rotating shaft with or without some offset. Tool 240 is coupled to a force control 230 unit output. Force controlled flange 230 provides a soft (i.e., not stiff) displacement curve. In most force control units, a single degree of freedom is provided by a sliding (prismatic) joint along the active axis. Force control 230 is coupled to a flange 220. Movement of components 210, 220, 230, 240 and 250 is all controllable using a robot controller (e.g., robot controller 270).

Robotic controller 270, in addition to moving components 210-250 based on the parameters of an abrading operation, may also adjust parameters based on information received from an abrasive article use evaluation 260. For example, if evaluation system 260 indicates that an abrasive article has reached an end of life, controller 270 may instruct system 200 to stop an abrading operation, change out the old abrasive article for a new abrasive article, and then continue an abrading operation. Additionally, for example, controller 270 may provide new parameters for abrading based on the feedback from system 260. For example, if an abrasive article loaded, controller 270 may increase a coolant flow to flush accumulated swarf. If the abrasive article is capped, controller 270 may initiate a dressing process to alleviate detected capping. If the abrasive article is worn, but not at end of life, controller may increase a force applied by force control unit 230, or may adjust an angle of tool 240 with respect to a substrate. Such adjustments are described in greater detail with reference to later figures.

FIG. 4 illustrates a hand tool 300 that may be used by a human operator during an abrading operation. Tool 300 includes an abrasive article 310 coupled to a backup pad 312. Tool is maneuverable by a human operator such that an angle of the abrasive article 310 is adjustable. An applied force may also be adjustable, for example by a human operator leaning into an operation.

While experienced human operators may be able to adjust operational conditions based on a “feel” of the abrading operation, at least some operators may benefit from an evaluation system 320. Abrasive article evaluation system 320 may detect use conditions of abrasive article 310 and evaluation communicator 330 may communicate a wear condition or operating condition of the abrasive article to the human operator. For example, tool 300 may include a display that provides instructions for a human operator-e.g. based on an internal gyroscope or accelerometer the tool may guide the user into adjusting an angle of the tool with respect to a surface. In other embodiments, communicator 330 may display results, instructions or suggestions on a display associated with the human operator-such as a display on protective gear worn by the user (e.g. a heads up display or an augmented reality overlay provided on safety glasses) or on a display in the area. Communicator 330 may also communicate results in another manner, such as audibly, or just by indicating that the abrasive article is acceptable for continued use or unacceptable for continued use.

Described herein are systems and methods for evaluating an abrasive article. The abrasive article may be associated with a robotic abrading system, like that illustrated in FIG. 3, or may be a human operated tool, like that illustrated in FIG. 4. Evaluating the abrasive article is broadly used to refer to evaluating a parameter related to abrasive efficiency of the abrasive article. Abrasive efficacy may be affected by wear-as the article is used and the particles ground down, the cut rate decreases. However, abrasive efficacy can also be affected by other factors that may be detectable using systems and methods herein. For example, capping or loading may occur, causing abrasive particle tips to be covered and unavailable for abrading. Other efficacy factors may also be detectable.

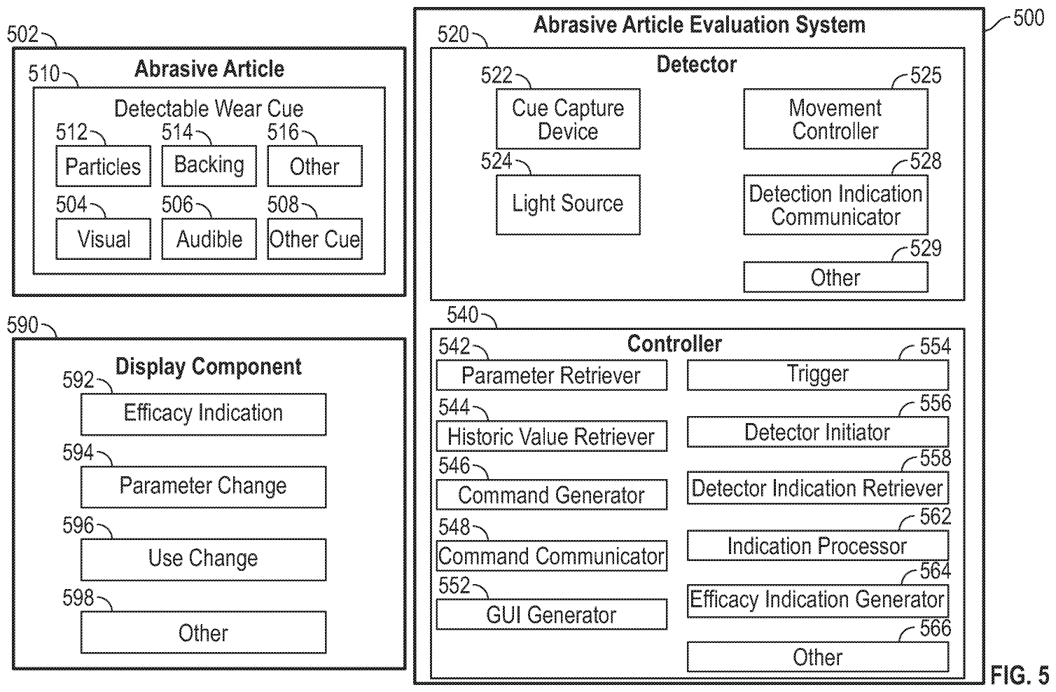

FIG. 5 illustrates an abrasive article evaluation system in accordance with embodiments herein. Abrasive article evaluation system 500 is suitably accessible for an abrasive article 502. For example, a robotic arm may move an abrasive article 502 in range of detector 502 with a cue capture device 522. In some embodiments herein, cue capture device 522 is a camera or other image capturing component that images the abrasive article 502. In other embodiments, cue capture device 522 is a sensor that captures another signal, such as a sound, a vibration, a weight, a thickness or another parameter of abrasive article 502 as described in embodiments herein. In embodiments where cue capture device 522 is a camera, detector 520 may also have a light source 524. The light source may provide illumination in the visual spectrum, ultraviolet spectrum, infrared spectrum or another wavelength suitable for detecting cue 510.

As described herein, an abrasive article 502 includes a cue 510 that can be detectable by a sensor 522. The cue may be incorporated into particles 512 within abrasive article 502, a backing 514 or resin structure, or another component 516 of the abrasive article. The detectable cue 510 may be a visual indication 504, an audible indication 506, or another cue 508. For example, cue 510 could be a detectable weight loss or shrinkage of an abrasive article 502 that is detectable by a scale or calipers.

Detector 520 may be stationary, such that a robotic arm or a human operator brings abrasive article 502 into range of cue capture device 522. In other embodiments, detector 520 is mobile, with a movement controller 525 that can move cue capture device 522, light source 524 or other component 529 into position to detect cue 510. Detector 520 may communicate a signal generated by cue capture device 522 using a detection indication communicator 528. However, it is expressly contemplated that, while detector 520 is illustrated in FIG. 5 as separate from a controller 540 that completes an evaluation, they may be a single component in some embodiments.

Controller 540 receives a detection indication from detector 520 using a detector indicator retriever 558. Detection indicator retriever 558 may request an indication from detector 520, in response to a detector initiator 556, which may send a command to detector 520 to actuate cue capture device 522. A trigger 554 may cause detector initiator 556 to actuate, in some embodiments. For example, a motion detector 554 may detect that abrasive article 502 has moved into position. Trigger 554 may also be time or position based.

Indication processor 562 processes the received signal from detector 520. As described herein, that may include comparing the received signal to a threshold, reviewing it against a historic signal value retrieved from a datastore by historic value retriever 544, or otherwise processing the signal to determine whether an abrasive efficacy of article 502 has reached an undesired low.

Indication process 562 may use a threshold that is set by a manufacturer, a customer, an operator, a shift supervisor, etc. For example, one customer may set a lowest acceptable thickness of an abrasive disc as T while a second sets the threshold at 2 T.

In some embodiments, controller 540 may determine that, while an abrasive efficacy has dropped below a threshold, it may be possible to improve by altering one or more operational parameters. Parameter retriever 542 may retrieve a current set of operating parameters-such as an applied force from a force control unit, an abrading angle from an accelerometer, etc. A command generator 546 may generate a command, for example to a robot arm controller to adjust an applied force or angle, which is then communicated to the robot arm controller, using command communicator 548. Command generator 546 may also generate a command to exchange abrasive article 502 for a new abrasive article, or to re-dress abrasive article 502 to remove loading or capping. In some embodiments, command generator 546 and command communicator 548 may operate automatically, such that a robot controller is continuously adjusting parameters to improve abrading efficacy.

An efficacy indication generator 564 generates an indication of an abrading efficacy of abrasive article 502. The indication may be displayed, for example on a display component 590. The indication may be provided in words, e.g. “60% used” or “capping detected” or may be provided as a simple “good” or “bad.” The indication may be audible, e.g. an alarm or signal indicating that action is needed to improve the abrading efficacy or to replace abrasive article 502. The indication may be provided to a graphical user interface generator 552, which may generate an interface for display component 590. Controller 540 may also have other functionality 566.

Display component 590 may be incorporated into a hand tool, in some embodiments, such that an efficacy indication 592 is visible to a user of the hand tool. In other embodiments, display component 590 is separate from a tool. For example, in a robotic abrading context, display component 590 may be separate from a robotic arm, but visible to an operator. In some embodiments, display component 590 is part of a mobile computing device, such as an operator's mobile phone or tablet. GUI generator 552 may then send an indication to an application running on the device, such that efficacy indication 592 can be updated.

Display component 590 may also present a parameter change 594, such as an adjustment of a tool angle, an increase or decrease in applied force, etc. A use change 596 may also be indicated. For example, a coated abrasive article that has experienced significant wear may no longer be appropriate for an initial high-volume abrading removal step of a process, but may be suitable for a later, lower-volume abrading removal step. Display component 590 may also provide other information 598, received from controller 540, detector 520 or elsewhere. For example, a unit count of parts completed, an average abrading time, or other relevant information may be displayed.

System 500 is illustrated as separate from display component 590 in FIG. 5, however it is expressly contemplated that a single computing unit may include display component 590 and some or all of the components of system 500. For example, detector 520 and controller 540 are illustrated as part of a single unit, it is expressly contemplated that at least some components may be part of separate devices. For example, controller 540 may be part of a robotic arm controller, a separate computing device remote from detector 520 and display component 590.

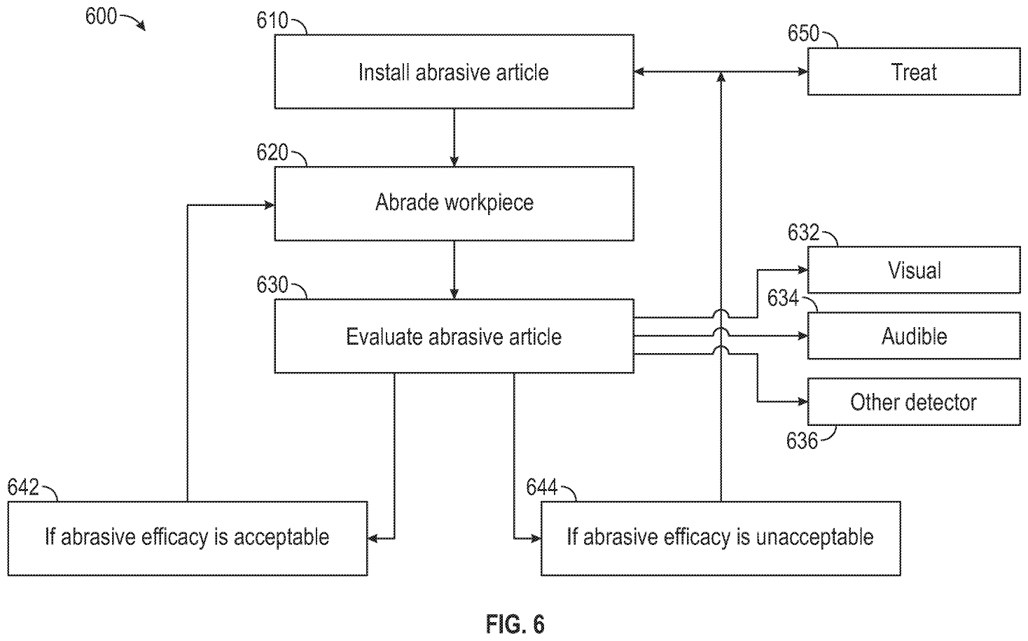

FIG. 6 illustrates a method of evaluating an abrasive article. In some embodiments, evaluating may be automatically completed using method 600. For example, a robotic arm or a human operator may move an abrasive article within range of, or past, a detector which may capture a signal indicative of abrading efficacy of the abrasive article.

In block 610, an abrasive article is installed on a tool. For example, the abrasive article may be coupled to a backup pad on a hand held abrasive tool or to a tool of a robotic abrading unit. The abrasive article may be any suitable abrasive article for a given abrading operation, such as a coated abrasive article, a bonded abrasive article, a bristle brush, or another suitable abrasive article.

In block 620, the abrasive article engages a workpiece and an abrading operation is conducted. As the workpiece is abraded, abrasive particles of the abrasive article experience wear. They may also experience capping, loading or other degradation.

In block 630, the abrasive article is evaluated. An abrading efficacy of the abrasive article is determined. A visual cue 632 may be analyzed to detect wear, capping or loading, in some embodiments. An audible cue 634 may be analyzed to detect wear, capping or loading. In other embodiments, a different detector 636 detects a cue of abrasive efficacy.

Evaluating the abrasive article may be done by directly measuring a parameter of the abrasive article, such as visual indicia, sounds, or other indicia of the abrasive article during or after an abrasive operation. In other embodiments, evaluating the abrasive article may be done by evaluating the workpiece, swarf removed from the workpiece, or another component.

Evaluation, in block 630, may be done automatically as part of an abrading process. For example, a robotic arm coupled to the abrasive article may change positions, for example while a completed workpiece is replaced by a new workpiece, such that the abrasive article is within range of a detector. Similarly, a human operator may set down an abrasive tool coupled to the abrasive article in a position within range of a detector while the human operator changes out a part to be abraded or completes another task.

In block 642, if the abrasive efficacy of the abrasive article is still at an acceptable level, then it can continue to be used for another abrasive operation. In some embodiments, new operational parameters are provided based on a detected decrease in abrasive efficacy between evaluations. In a robotic abrading operation, the new parameters may be automatically implemented. In a handheld tool context, the new parameters may be suggested to an operator.

In block 644, if the abrasive efficacy is below an acceptable level, it can either be treated, as indicated in block 650, for example by dressing the abrasive article to remove capping, washing or cleaning the abrasive article to remove loading. However, in some embodiments, method 600 returns to block 610.

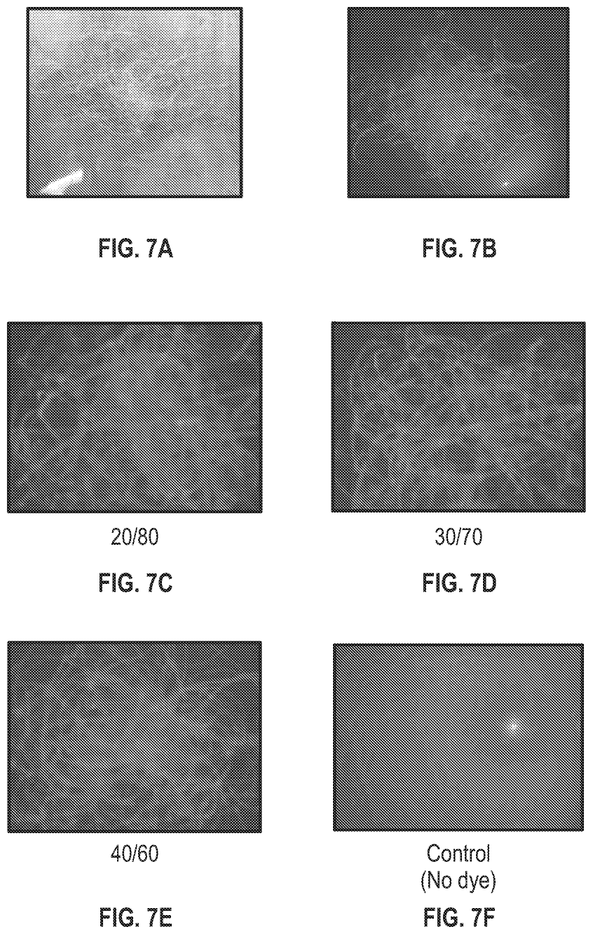

Described herein in FIGS. 7-12 are examples and embodiments of the present invention where a detected indication of abrasive efficacy are visual in nature. However, it is expressly contemplated, and described in co-pending applications 63/366,803 and 63/366,805, both filed on Jun. 22, 2022, that other abrasive efficacy cues are possible.

FIGS. 7A-7F illustrate fluorescent nonwoven fibers that can be used in embodiments herein. FIG. 7A illustrates fibers seen under the visual light spectrum, and FIG. 7B illustrates the same nonwoven fibers glowing bright blue when under a blacklight. FIGS. 7C-7E illustrate different ratios of dye incorporated into the fibers. FIG. 7F illustrates control fibers, with no dye incorporated, showing that the dyed fibers can be detected while undyed fibers may either be undetected or have only a negligible amount of fluorescence. The nonwoven fibers have fluorescent dye incorporated into them during the fiber making process. The fibers can then be incorporated into a nonwoven abrasive backing, which can be coated in resin and abrasive particles. If applied in a spray coat application, or a dip/roll coat application, the resin would cover the majority of the fibers. As the abrasive article is used and the resin and abrasive particles degrade, the fibers will again be exposed. Over time, more and more fluorescence will be detected as the slurry spray layer is abraded away.

While FIGS. 7A-7F concern fluorescent nonwoven fibers, use of fluorescent light may be useful for other applications as well. For example, backing of a coated abrasive article may have fluorescent dye similarly incorporated.

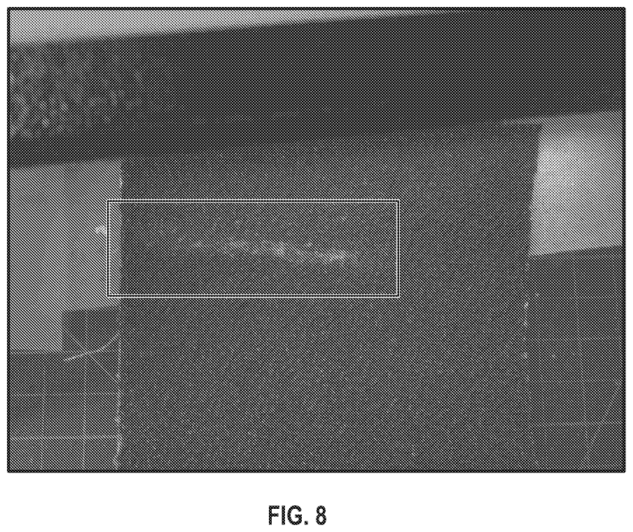

FIG. 8 illustrates using a fluorescent light to detect degradation of an abrasive article in accordance with embodiments herein. FIG. 8 illustrates an abrasive belt (specifically a 784F 36+ Cubitron™ II Belt from 3M Company), with fluorescent dye incorporated into the polyester backing, held in front of a fluorescent light. In areas where the abrasive particles and resin matrix have been worn away to expose the backing, the fluorescent light shines through.

Incorporating a UV fluorescent indicator in coated abrasive backings or resin/mineral layers can allow for easy in-situ evaluation of an abrasive article, serving as an end of life indicator. This may allow for both robotic cell operators and human operators to know when to change out used coated abrasive belts or discs. As the coated abrasive is used and erosion of resin/mineral layers occur, the backing will be exposed, and the UV fluorescent indicator will be detected. A suitable detector may be a UV spectrophotometer device attached to a robotic arm or otherwise placed in the vicinity of a human operator. The depth of erosion detection for coated abrasive can be varied depending on placement of UV fluorescent indicator. For example, it can be placed in the backing, make resin layer, or size resin layer. The UV fluorescent indicators are typically dyes that fluoresce under UV light. As shown in FIG. 8, a section of 784F 36+ was eroded to backing and was easily detected with UV light. The UV fluorescent end of life detection system is a highly effective method to determine coated abrasive end of life for manual operations or automatic robotic grinding and finishing operations.

While fluorescent light has been described in detail, there are other options for visual cues that may be readily detectable. In other embodiments, a state-changing or reactive material is encapsulated and enclosed within the abrasive article. When the encapsulation is abraded away or heated due to the friction of an abrasive operation, the material changes state. The material may melt, burn or sublimate to produce a detectable visual cue. Similarly, a reaction may occur such that smoke or haze is created. The reactive material could be, for example, sodium that reacts when exposed to air. A material that reacts to air (dry sanding) or water (wet sanding) could be used to provide a detectable end of life indication. Waxes and polymers may be used to encapsulate a dye, fragrance or a smoking material. In some embodiments, as the temperature increases due to the increased friction of worn abrasive materials against a surface, the encapsulating material melts and the encapsulated material is released and detectable. In some embodiments, the encapsulating material is worn away instead of melted.

The material may also change a color of the abrasive disc or swarf produced. For example, encapsulated wax could change a red abrasive disc to appear purple. The color change may be detectable by a human operator, or by a spectrometer.

In some embodiments, the material has a smell when released, that is detectable by the human nose or an odor meter.

Additionally, in some embodiments a spark shower is generated as the material interacts with a workpiece. For example, both titanium and cast iron have an identifiable spark shower. Titanium or other particles placed in the backfill layer will give different color spark showers. Flint or other materials can be used to give an increase in spark shower. The spark generating material can also be incorporated as a wire or strand in the backing.

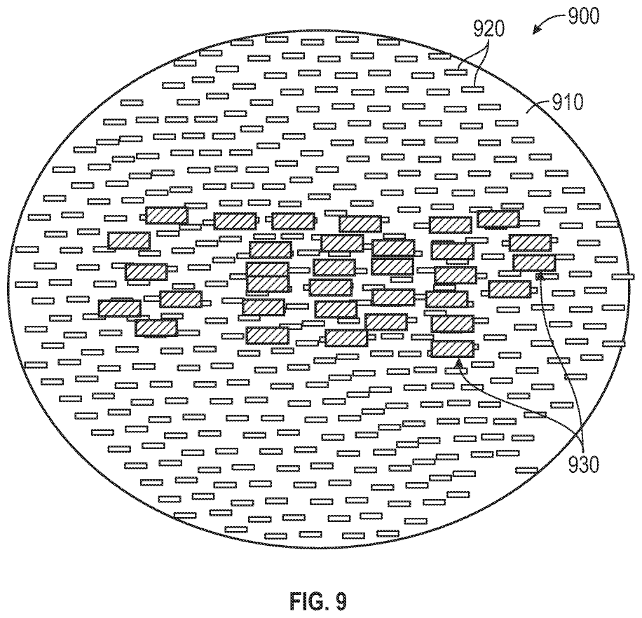

FIG. 9 illustrates a schematic of an abrasive article in accordance with embodiments herein. Abrasive article 900 has a backing 910, abrasive particles 920 having a first color and a material 930 having a second color. Material 930 may also be abrasive particles in some embodiments, with a color different than the first color. The second abrasive particles 930 may be placed in a pattern, for example as described in US PAP No. 2022/0040814, published on Feb. 10, 2022.

Material 930 may be a separate type of abrasive particles than particles 920, for example backfill or other crushed abrasive particles. Material 930 may also be a dye, ink or printing on one of the layers of article 900, for example on backing, a make coat, a size coat or another layer. FIG. 9 illustrates an embodiment where material 930 spells out a word—“STOP”—however it is expressly contemplated that another visual cue may be apparent, such as a brand, a shape, or another suitable visual indication.

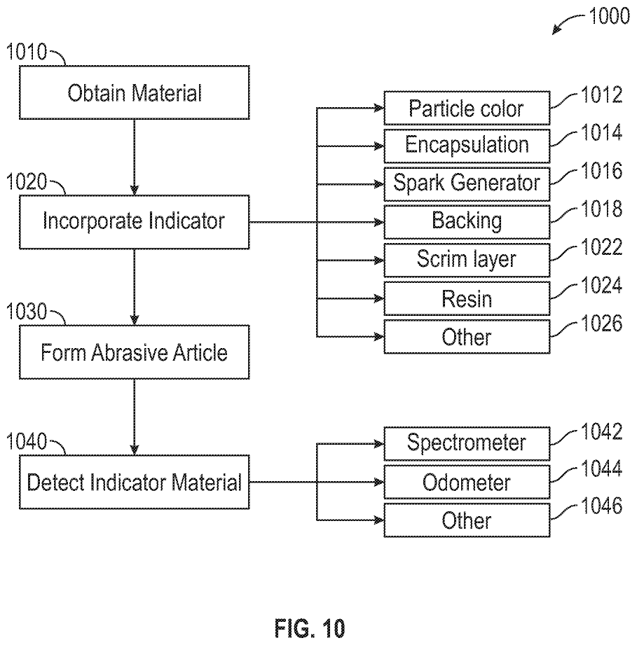

FIG. 10 illustrates a method of making an abrasive article with a detectable cue in accordance with embodiments herein. Method 1000 may be used to make an abrasive article that can be used by a robotic abrading system or a human operator and provide an indication of abrading efficacy. The indication may be an end of life indication, an indication that new operational parameters are needed to improve abrasive efficacy, or an indication that the abrasive article is no longer suitable for a current operation, but might be suitable for a downstream abrading operation.

In block 1010, an indicator material is obtained. The indicator material may be a colored dye, a scent, a spark-generating material, a smoke or haze creating material, a material reactive with air or water, or another material that generates a detectable indication of abrasive efficacy.

In block 1020, the indicator material may be incorporated into abrasive particles, for example a dye that imparts a color 1012. The indicator may be encapsulated 1014, and incorporated into a binder layer. For example, colored wax may be incorporated into an abrasive article by encapsulation, or a material that smokes or produces a detectable smell. The indicator may also be a spark generating material 1016, for example titanium, iron or copper.

The indicator material may be part of a resin or binder layer, a backing, a scrim layer. For example, an abrasive article backing 1018 may have an indicator such as fluorescent dye, or a printed indication. The indicator may also be part of a scrim layer 1022, for example fluorescent dye or printing. The indicator may be incorporated into a resin layer 1024, or may otherwise be incorporated into another component 1026 of the abrasive article.

In block 1030, the abrasive article is formed. For example, the dyed fibers are incorporated into a backing, the encapsulated colored wax is used as part of a resin that cures to form the abrasive article, the colored abrasive particles are suitably arranged.

The nature of the uncured or partially cured resin composition is non-limiting. For example, the uncured or partially cured resin composition can comprise any suitable materials that can be cured form a make coat. Suitable materials for forming abrasive layer include phenolic resins (e.g., PREFERE 80 5077A from Arclin, Mississauga, Ontario, Canada). Suitable phenolic resins are generally formed by condensation of phenol or an alkylated phenol (e.g., cresol) and formaldehyde, and are usually categorized as resole or novolac phenolic resins. Novolac phenolic resins are acid-catalyzed and have a molar ratio of formaldehyde to phenol of less than 1:1. Resole (also resol) phenolic resins can be catalyzed by alkaline catalysts, and the molar ratio of formaldehyde to phenol is greater than or equal to one, typically between 1.0 and 3.0, thus presenting pendant methylol groups. Alkaline catalysts suitable for catalyzing the reaction between aldehyde and phenolic components of resole phenolic resins include sodium hydroxide, barium hydroxide, potassium hydroxide, calcium hydroxide, organic amines, and sodium carbonate, all as solutions of the catalyst dissolved in water.

Resole phenolic resins are typically coated as a solution with water and/or organic solvent (e.g., alcohol). Typically, the solution includes about 70 percent to about 85 percent solids by weight, although other concentrations may be used. If the solids content is very low, then more energy is required to remove the water and/or solvent. If the solids content is very high, then the viscosity of the resulting phenolic resin is too high which typically leads to processing problems.

Phenolic resins are well-known and readily available from commercial sources. Examples of commercially available resole phenolic resins useful in practice of the present disclosure include those marketed by Durez Corporation under the trade designation VARCUM (e.g., 29217, 29306, 29318, 29338, 29353): those marketed by Ashland Chemical Co. of Bartow, Florida under the trade designation AEROFENE (e.g., AEROFENE 295): and those marketed by Kangnam Chemical Company Ltd. of Seoul, South Korea under the trade designation PHENOLITE (e.g., PHENOLITE TD-2207).

The uncured or partially cured resin composition that is converted to cured resin composition can comprise additional components, including polyurethane dispersions, such as aliphatic and/or aromatic polyurethane dispersions. For example, polyurethane dispersions can comprise a polycarbonate polyurethane, a polyester polyurethane, or polyether polyurethane. The polyurethane can comprise a homopolymer or a copolymer.

The abrasive article may be a coated abrasive article with abrasive particles embedded in a resin layer on a suitable backing—cloth, nonwoven fiber, paper, film, foam, etc. The abrasive article may be a bonded abrasive article, with abrasive particles embedded in a bond matrix such as a resinous or vitreous bond matrix.

In block 1040, the indicator is detected as the abrasive efficacy of the abrasive article decreases below a suitable threshold. For example, the abrasive particles may be suitably worn down that encapsulated material is exposed and reacts, causes sparking, or changes a color of the abrasive article surface. The abrasive article may degrade enough that an indicator on or in the backing is exposed. The indicator may be detectable using a spectrometer 1042, an odometer 1044, or another suitable sensor, such as an ionization chamber or photoelectric sensor to detect smoke.

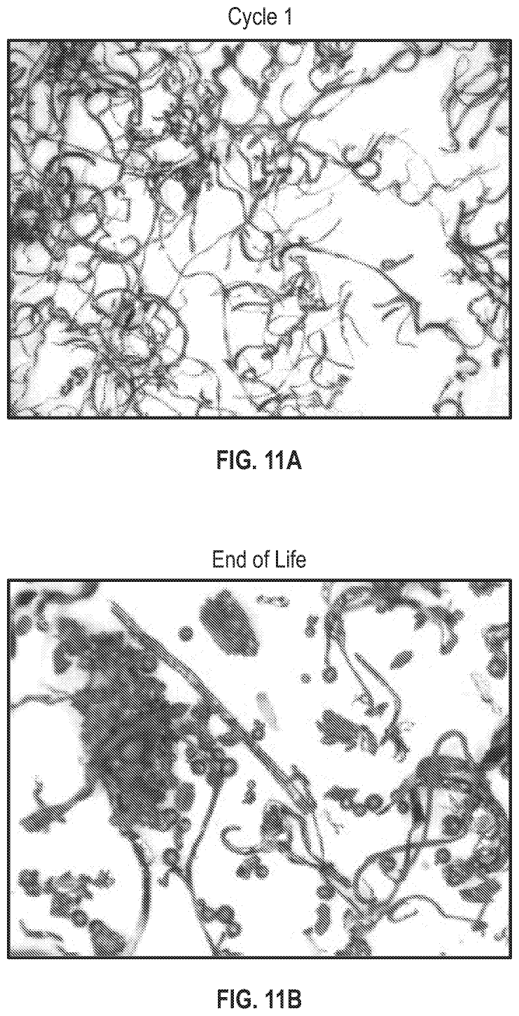

FIGS. 11A-11B illustrate images of swarf from an abrasive article in accordance with embodiments herein. It may be possible to get an indication of abrasive efficacy by inspecting other components of an abrasive operation. FIGS. 11A-11B illustrate how swarf produced from an abrading operation changes from a first cycle (FIG. 11A) to a cycle near the end of an abrasive article life (FIG. 11B). As illustrated, during early use of an abrasive article of a metal substrate, the swarf is thin and fibrous, like shavings, whereas at the end of an abrasive article's useful life the swarf clumps and produces spherical shapes, like powder. This is likely due to increased heat produced as the abrasive efficacy decreases can cause metal to melt and form spherical droplets. Swarf formed at the end of an abrasive life may also be different in color, often darker than swarf formed in an earlier part of an abrasive article's service life.

In the case of a robotic abrading operation, a camera on an end-of-arm mounting position may be able to image swarf as an abrading operation progresses. The camera may be any suitable camera capable of capturing images of swarf, which may include particulates on the order of microns. The robotic arm may also include a light source if needed. In one embodiment, a swarf collecting device, such as a conveyer belt, a funnel or other suitable conveyance mechanism, collects swarf produced from an abrasive operation and moves the swarf to a sensor.

Swarf-imaging may be more suitable for estimating abrading efficacy of grinding wheels on metal substrates. However, it may also be suitable for abrading efficacy on hard substrates like wood, where splinter patterns would be changed or discolored due to burning.

Described herein are techniques for visually detecting a change in an abrasive article, waste product or other attribute of an abrasive operation. However, one other indicator of abrasive particle degradation is the change in temperature of an abrasive operation. As the surface area of abrasive particles contacting a surface increases (e.g. as precisely shaped abrasive particles are worn down from a tip to a particle base), the temperature of an abrasive operation increases because of increased friction. An infrared detecting sensor, such as a camera or thermometer, may be able to detect an increase in temperature. Based on known properties of an abrasive article (e.g. particle density, resin composition, particle composition, etc.) and abrasive operation (e.g. substrate, speed, applied force, etc.), a temperature threshold, and corresponding infrared spectra, may be set.

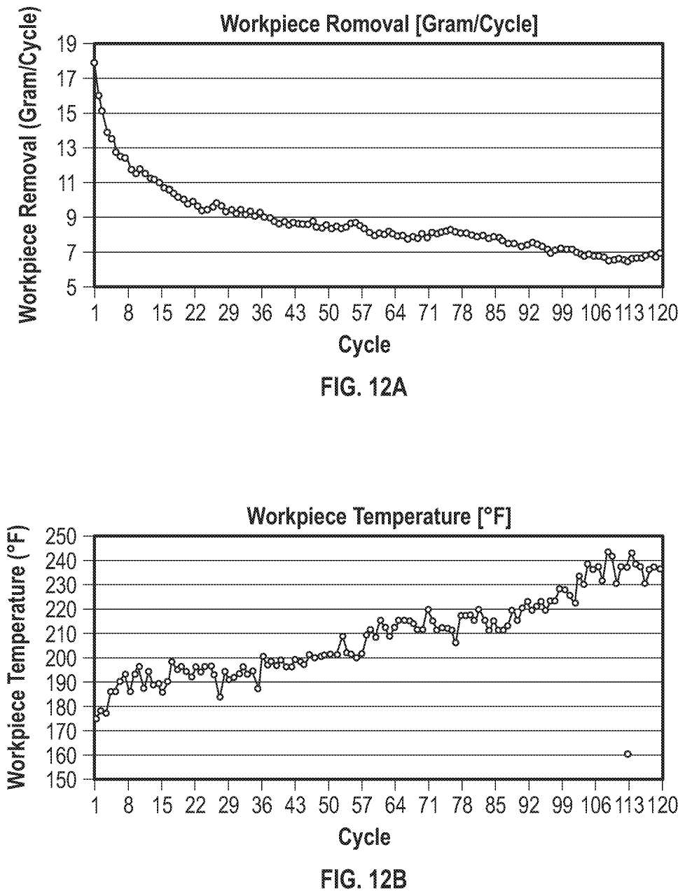

In some embodiments, a sensor does not detect an infrared spectra, but a different parameter related to operational temperature. As illustrated in FIGS. 12A-12B, as the abrasive article us used, and wears down, in addition to a material removal rate dropping off, a substrate temperature rises. Measuring a temperature over time may allow for detection of this temperature increase and correlate that to a wear of an abrasive article and/or to a need to adjust operating parameters for a next abrasive operation.

Additionally, a thermally activated component in a resin layer or on the substrate itself may indicate a temperature, or temperature change, and provide an indication of wear. For example, a thermally activated dye or wax may be present in a make coat. As the make coat heats up, the dye is released, or the wax melts, creating a visual indication that an operator or sensor can detect.

In some embodiments, a heat activated dye or wax changes color at a temperature threshold indicative of an end of life, or within an expected end of life timeframe. E.g. 50% time remaining or 25% particle height remaining.

Similarly, indicators may be held within encapsulated wax that, when the wax melts, are released and, due to centripetal force, are pulled to the outside of an abrasive disc and are therefore detectable.

Abrasive particles may also have a layer of wax applied thereon, which may release a colored dye or other indicator when a temperature threshold is released.

In some embodiments, an abrasive disc is brought near a sensor, such as a camera or thermometer, in between abrasive operation cycles, such that the temperature can be detected. In some embodiments, a thermometer or sensor is constantly monitoring the abrasive article. For example, a thermocouple may be built into the backup pad or contact wheel of an abrasive belt, or a camera set up so that the abrasive operation is within a field of view and images are captured over time during an abrasive operation.

An abrasive disc also physically changes during an abrasive operation. As abrasive particles engage a substrate, they fracture or are otherwise ground down, losing mass. A bonded wheel reduces in thickness overtime as abrasive particles are used up or fall out due to shelling. The change in thickness is measurable, for example using calipers. Similarly, a bonded abrasive wheel, nonwoven or coated abrasive article also experiences changes in weight as abrasive particles are ground down or removed. This change in weight may be measured, either using a force control unit of a robotic abrasive unit, or by placing the abrasive article on a scale for measurement. In some embodiments, the abrasive article may first be rapidly rotated without contacting a substrate to remove entrained water, polish or debris. In some embodiments, entrained material is corrected for by a correction factor that is calculated for each abrasive operation based on a database of abrasive operation data that allows for machine learning to predict weights of entrained material.

In some embodiments, only a weight change is monitored, instead of an absolute weight of an abrasive article. This may eliminate some concerns about entrained material. As an abrasive article approaches the end of service life, the loss of abrasive grains increases due to shelling, which results in a detectable change in weight. The change in weight may be detectable by a sensitive enough force control unit, or using a scale.

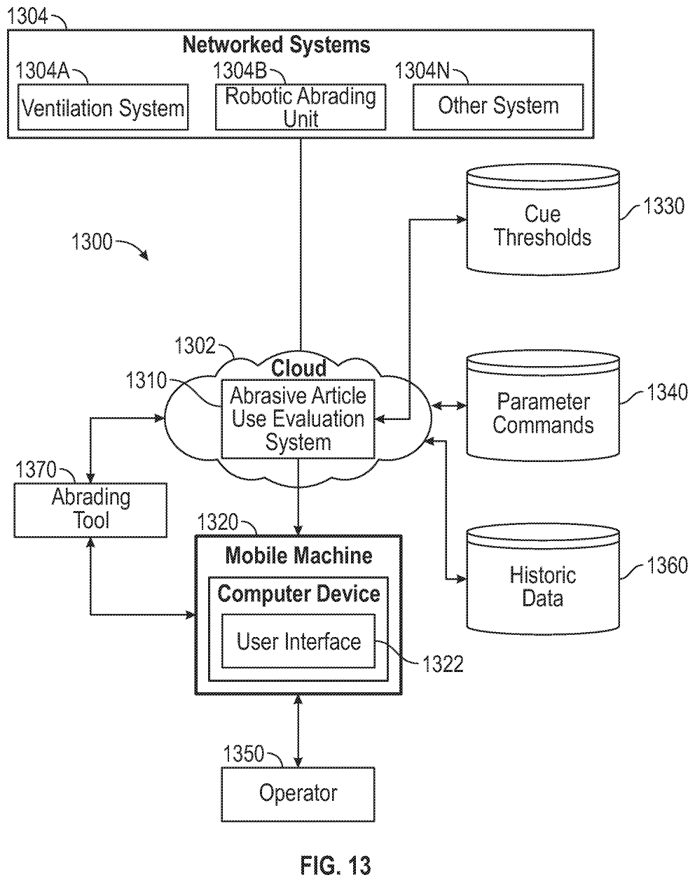

FIG. 13 is a networked architecture for an abrasive article use evaluation system 1310. Architecture 900 illustrates one embodiment of an implementation of a system 1310, however others are possible. In various embodiments, remote servers can deliver the services over a wide area network, such as the internet, using appropriate protocols. For instance, remote servers can deliver applications over a wide area network and they can be accessed through a web browser or any other computing component.

Software or components, as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

As described herein, based on an indication from abrasive article use evaluation system 1310, a robotic abrading unit 1304B, in response to a command received over a wired or wireless network (e.g. retrieved from commands datastore 1340), may adjust a force or speed or another parameter relevant to an abrasive operation.

Knowing when an abrasive article is nearing an end-of-life may allow for improved environmental health and safety for workers in the immediate environment, in addition to improved efficiency benefits to the abrasive operation. For example, it is known that more fine dust is produced near the end of life of an abrasive article than at the beginning. Knowing whether an abrasive article(s) in use is near end of life can, for example, be the trigger for a command to be sent to a ventilation system 1304A to increase ventilation in response to the higher dust production. Similarly, a setting for ventilation system 1304A may be reduced when an abrasive article is nearer to the beginning of its useful life. A trigger for changing the ventilation settings may be generated using any of the end-of-life detection methods herein, including detecting visual cues, detecting a change in temperature, detecting physical changes, or by examining swarf.

Similarly, it may be useful to know how used an abrasive article is-not for replacement, but for downstream repairs. Generally, abrasive operations start with the coarsest grade and work down to finer grades to polish a substrate surface. For example, first a 60 grit disc, then an 80 grit disc, before finally a 120 disc. However, if it is known that the 60 grit disc is near its end of life, it will not leave as many scratches, and the 80 grit abrading step may be skipped entirely, progressing directly to the 120 grit disc. While such a decision may be made by an experienced operator, similar guidance may be helpful for newer operators, and may increase efficiency of robotic abrading systems.

FIG. 13 specifically shows that a system 1310 can be located at a remote server location 1302. Therefore, computing device 1320 accesses those systems through remote server location 1302. Operator 1350 can use computing device 1320 to access user interfaces 1322 as well. For example, user interface 1322 may provide an indication of how worn an abrasive article is, changes that are made to any of networked systems 904, or suggested changes to the operation by the operator-such as increasing force, increasing RPMs, etc.

FIG. 13 shows that it is also contemplated that some elements of systems described herein are disposed at remote server location 1302 while others are not. By way of example, storage 1330, 1340 or 1360 or robotic systems 1370 can be disposed at a location separate from location 1302 and accessed through the remote server at location 1302. Regardless of where they are located, they can be accessed directly by computing device 1320, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

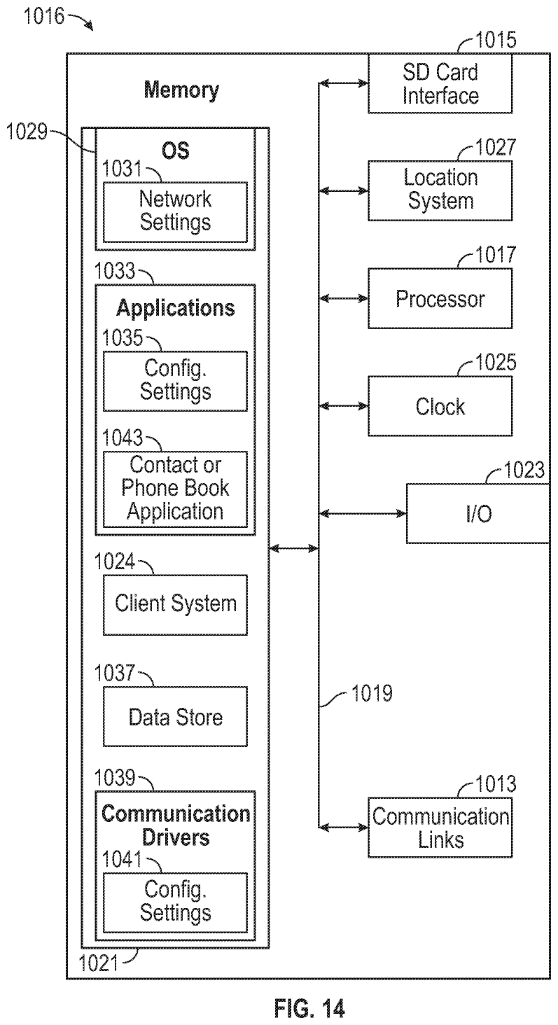

FIGS. 14-16 show examples of computing devices that can be used in embodiments shown in previous Figures.

FIG. 14 is a simplified block diagram of one illustrative example of a handheld or mobile computing device that can be used as a user's or client's handheld device 16 (e.g., as computing device 1320 in FIG. 13), in which the present system (or parts of it) can be deployed. For instance, a mobile device can be deployed in the operator compartment of computing device 1320 for use in generating, processing, or displaying the data. FIGS. 14 is another example of a handheld or mobile device.

FIG. 114 provides a general block diagram of the components of a client device 1016 that can run some components shown and described herein. Client device 1416 interacts with them, or runs some and interacts with some. In the device 1416, a communications link 1413 is provided that allows the handheld device to communicate with other computing devices and under some embodiments provides a channel for receiving information automatically, such as by scanning. Examples of communications link 1413 include allowing communication though one or more communication protocols, such as wireless services used to provide cellular access to a network, as well as protocols that provide local wireless connections to networks.

In other examples, applications can be received on a suitable removable memory card (such as an Secure Digital (SD) card, CF card, microSD or portable hard drive) that is connected to an interface 1415. Interface 1015 and communication links 1413 communicate with a processor 1417 (which can also embody a processor) along a bus 1419 that is also connected to memory 1421 and input/output (I/O) components 923, as well as clock 1425 and location system 1427.

I/O components 1423, in one embodiment, are provided to facilitate input and output operations and the device 1416 can include input components such as buttons, touch sensors, optical sensors, microphones, touch screens, proximity sensors, accelerometers, orientation sensors and output components such as a display device, a speaker, and or a printer port. Other I/O components 1423 can be used as well.

Clock 1425 illustratively comprises a real time clock component that outputs a time and date. It can also provide timing functions for processor 1417.

Illustratively, location system 1427 includes a component that outputs a current geographical location of device 1416. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1421 stores operating system 1429, network settings 1431, applications 1433, application configuration settings 1435, data store 1437, communication drivers 1439, and communication configuration settings 1441. Memory 1421 can include all types of tangible volatile and non-volatile computer-readable memory devices. It can also include computer storage media (described below). Memory 1421 stores computer readable instructions that, when executed by processor 1417, cause the processor to perform computer-implemented steps or functions according to the instructions. Processor 1017 can be activated by other components to facilitate their functionality as well.

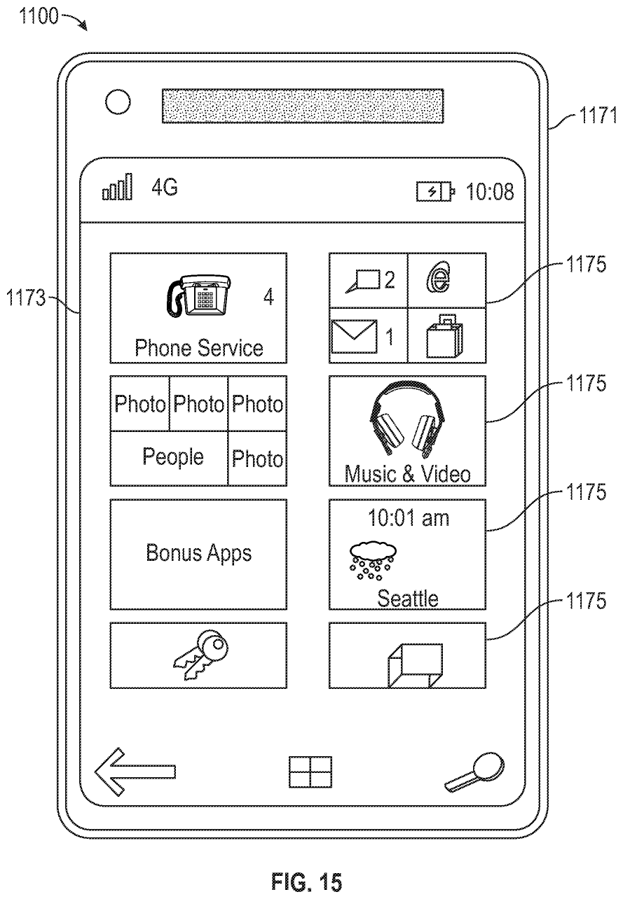

FIG. 15 shows that the device can be a smart phone 1501. Smart phone 1571 has a touch sensitive display 1573 that displays icons or tiles or other user input mechanisms 1575. Mechanisms 1575 can be used by a user to run applications, make calls, perform data transfer operations, etc. In general, smart phone 1571 is built on a mobile operating system and offers more advanced computing capability and connectivity than a feature phone.

Note that other forms of the devices 1516 are possible.

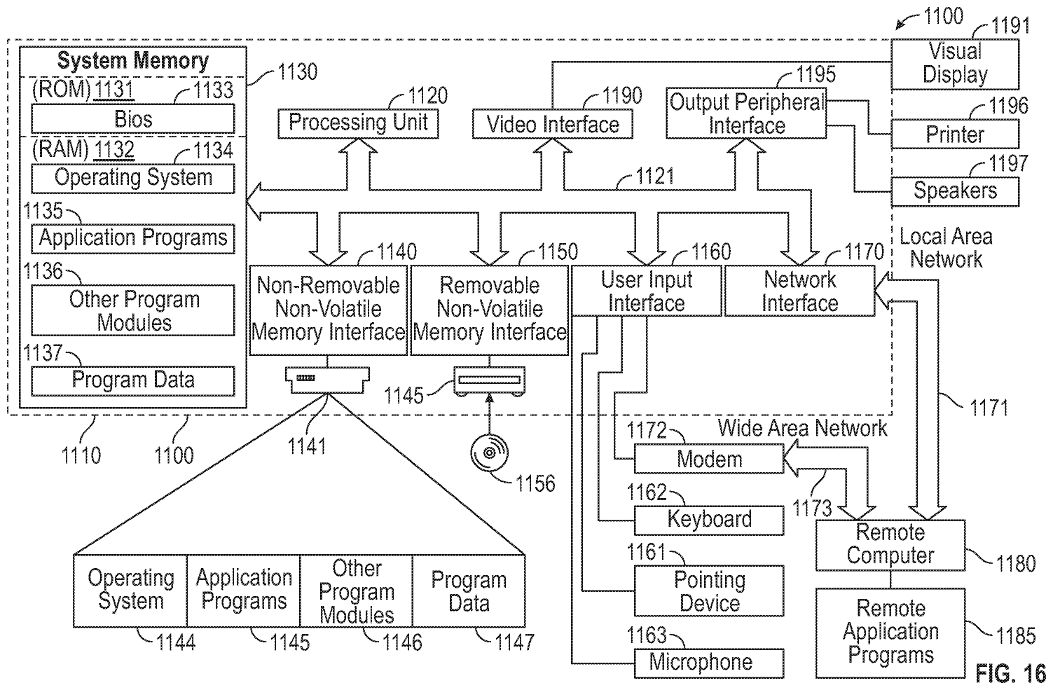

FIG. 16 is a block diagram of a computing environment that can be used in embodiments shown in previous Figures.

FIG. 16 is one example of a computing environment in which elements of systems and methods described herein, or parts of them (for example), can be deployed. With reference to FIG. 16, an example system for implementing some embodiments includes a general-purpose computing device in the form of a computer 1610. Components of computer 1610 may include, but are not limited to, a processing unit 1620 (which can comprise a processor), a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. Memory and programs described with respect to systems and methods described herein can be deployed in corresponding portions of FIG. 16.

Computer 1610 typically includes a variety of computer readable media. Computer readable media can be any available media that can be accessed by computer 1610 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1630 includes computer storage media in the form of volatile and/or nonvolatile memory such as read only memory (ROM) 1631 and random access memory (RAM) 1632. A basic input/output system 1633 (BIOS) containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable and volatile/nonvolatile computer storage media. By way of example only, FIG. 16 illustrates a hard disk drive 1641 that reads from or writes to non-removable, nonvolatile magnetic media, nonvolatile magnetic disk 1652, an optical disk drive 1655, and nonvolatile optical disk 1656. The hard disk drive 1641 is typically connected to the system bus 1621 through a non-removable memory interface such as interface 1640, and optical disk drive 1655 are typically connected to the system bus 1621 by a removable memory interface, such as interface 1650.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, application programs 1645, other program modules 1646, and program data 1647. Note that these components can either be the same as or different from operating system 1634, application programs 1635, other program modules 1636, and program data 1637.

A user may enter commands and information into the computer 1610 through input devices such as a keyboard 1662, a microphone 1663, and a pointing device 1661, such as a mouse, trackball or touch pad. Other input devices (not shown) may include a joystick, game pad, satellite receiver, scanner, or the like. These and other input devices are often connected to the processing unit 1620 through a user input interface 1660 that is coupled to the system bus, but may be connected by other interface and bus structures. A visual display 1691 or other type of display device is also connected to the system bus 1621 via an interface, such as a video interface 1690. In addition to the monitor, computers may also include other peripheral output devices such as speakers 1697 and printer 1696, which may be connected through an output peripheral interface 1695.

The computer 1610 is operated in a networked environment using logical connections, such as a Local Area Network (LAN) or Wide Area Network (WAN) to one or more remote computers, such as a remote computer 1680.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. In a networked environment, program modules may be stored in a remote memory storage device. FIG. 16 illustrates, for example, that remote application programs 1685 can reside on remote computer 1680.

Objects and advantages of this disclosure are further illustrated by the following non-limiting examples, but the particular materials and amounts thereof recited in these examples, as well as other conditions and details, should not be construed to unduly limit this disclosure.

An abrasive article evaluation system includes a detector that detects an abrasive wear cue. The system also includes an efficiency indication generator that, based on the abrasive wear cue, generates an indication of wear for the abrasive article. The system also includes a command generator that generates a command based in the generated indication of wear.

The system may be implemented such that it includes a parameter retriever that retrieves a current operational parameter for a tool associated with the abrasive article. The command generator generates a command to adjust the operational parameter from a first value to a second value, different from the first value.

The system may be implemented such that the operational parameter is an applied force, the tool is a robotic abrading unit and the second value is a higher applied force than a first applied force.

The system may be implemented such that the operation parameter is a speed. A second speed is higher than a first speed.

The system may be implemented such that the operation parameter is an angle. A second angle is different from a first angle.

The system may be implemented such that the command is a replacement command and a robotic abrading unit associated with the abrasive article initiates an abrasive article replacement sequence automatically, based on the command.

The system may be implemented such that the command is a downstream operation command that, based on the indication of wear, adjusts a downstream abrading operation parameter.

The system may be implemented such that the downstream abrading operation parameter is a speed, a force or a dwell time.

The system may be implemented such that the downstream abrading operation parameter is a second abrasive operation with a second abrasive article.

The system may be implemented such that a historic value retriever that retrieves a historic value for the operational parameter.

The system may be implemented such that the detector detects the cue in response to a detection initiator, which generates a trigger to actuate the detector.

The system may be implemented such that the detection initiator generates the trigger periodically.

The system may be implemented such that the detection initiator generates the trigger in response to a manual input.

The system may be implemented such that the detection initiator generates the trigger before an abrading operation starts.

The system may be implemented such that the detection initiator generates the trigger at an end of an abrading operation.

The system may be implemented such that the command is a graphical user interface update command, and the command is communicated to a device with a display. The command causes the display to present an updated graphical user interface.

The system may be implemented such that it includes a command communicator that communicates the command to a second device.

The system may be implemented such that the second device is a robotic abrading unit.

The system may be implemented such that the second device is a ventilation system.

The system may be implemented such that the second device is a dust collection system.

The system may be implemented such that the detector includes a cue capture device.

The system may be implemented such that the cue capture device is a camera.

The system may be implemented such that the cue capture device is a temperature measuring device.

The system may be implemented such that the temperature measuring device includes a thermocouple incorporated into a backup pad.

The system may be implemented such that the temperature measuring device includes an infrared camera.

The system may be implemented such that the cue capture device is a scale. The cue is a weight of the abrasive article.

The system may be implemented such that the cue capture device is a calipers. The cue is a thickness of the abrasive article.

The system may be implemented such that the detector includes a movement mechanism and a movement controller that moves the detector into position.

The system may be implemented such that the detector includes a light source.

The system may be implemented such that the wear cue is a spark, and the cue capture device captures an increase or change in sparking.

The system may be implemented such that the command is a redress command to redress the abrasive article.

The system may be implemented such that the command is a treatment command to treat the abrasive article to remove loaded material.

A robotic abrading system is presented that includes an abrasive article including a wear cue. The system also includes a backup pad coupled to the abrasive article. The system also includes a robot arm configured to move the abrasive article into position with respect to a substrate. The system also includes a force control unit, on the robot arm and coupled to the backup pad. The force control unit applies a force to the backup pad. The system also includes a wear indication system that determines an amount of wear of the abrasive article based on the wear cue, and, based on the amount of wear, an operational parameter of the robotic abrading system is adjusted.

The robotic abrading system may be implemented such that a detector that detects the wear cue, an efficiency indication generator that generates an abrasive efficiency for the abrasive article, and a command generator that generates a command to adjust the operational parameter.

The robotic abrading system may be implemented such that the detector includes an ultraviolet light source, the wear cue is a fluorescent material on the abrasive article, and the generated abrasive efficiency is based on a detected area of the fluorescent material.

The robotic abrading system may be implemented such that the wear cue is a heat activated material that changes color at a temperature threshold. The detector includes a camera.

The robotic abrading system may be implemented such that the wear cue is an operational temperature. The detector includes a temperature sensor.

The robotic abrading system may be implemented such that the temperature sensor includes a thermocouple within the backup pad.

The robotic abrading system may be implemented such that the temperature sensor includes an infrared camera.

The robotic abrading system may be implemented such that the temperature sensor includes a thermometer.

The robotic abrading system may be implemented such that the detector includes a scale. The robotic arm provides the abrasive article to the scale in between abrasive operations.

The robotic abrading system may be implemented such that the detector includes the force control unit. The force control unit detects a change in weight of the abrasive article.

The robotic abrading system may be implemented such that the detector includes a calipers. The robotic arm provides the abrasive article to the calipers in between abrasive operations.

The robotic abrading system may be implemented such that the detector includes a camera that images the abrasive article.

The robotic abrading system may be implemented such that the camera images a surface of the abrasive article.

The robotic abrading system may be implemented such that an image from the camera is analyzed by the efficiency indication generator and a visual indication of wear is detected.

The robotic abrading system may be implemented such that the visual indication is a change in color, a message, a haze, or a smoke.

The robotic abrading system may be implemented such that the detector includes a camera that images swarf produced during the abrasive operation.

The robotic abrading system may be implemented such that the detector identifies spherical or circular shapes in the swarf produced.

The robotic abrading system may be implemented such that the operational parameter is an automatic shutdown.

The robotic abrading system may be implemented such that the automatic shutdown is based on a temperature threshold.

The robotic abrading system may be implemented such that the operational parameter is an applied force by the force control unit, a rotational speed of the abrasive article, or a dwell time of the abrasive article on the substrate.

The robotic abrading system may be implemented such that the operational parameter is a parameter for a future abrasive operation on the substrate.

The robotic abrading system may be implemented such that the operational parameter is a parameter for a future abrasive operation using the abrasive article.

The robotic abrading system may be implemented such that the detector is mounted on the robot arm.

The robotic abrading system may be implemented such that it includes a movement mechanism that moves the detector relative to the robotic arm. The detector is independent of the robotic arm.

The robotic abrading system may be implemented such that the detector actuates a detection sequence in response to a detection initiation command from a controller.

The robotic abrading system may be implemented such that the controller sends the detection initiation command periodically.

The robotic abrading system may be implemented such that the controller sends the detection initiation command at a start of, or at an end of, an abrading operation.

The robotic abrading system may be implemented such that the controller generates the command to adjust the operation parameter.

The robotic abrading system may be implemented such that the wear indication system includes a historic value retriever that retrieves a historic value of the wear cue, and a wear processor that determines an amount of wear based on the wear cue and the retrieved historical value.

The robotic abrading system may be implemented such that the historic value is a last captured wear cue.

The robotic abrading system may be implemented such that the historic value is an initial wear cue.

The robotic abrading system may be implemented such that it includes a light source coupled to the robotic arm.

A wear detector for an abrasive article is presented that includes a cue capture device positioned proximate the abrasive article such that a wear cue associated with the abrasive article is detected. The detector also includes an efficacy indication generator that receives the detected wear cue and provides a wear indication based on the detected wear cue. The detector also includes a wear communicator that communicates the detected wear cue to a second device.

The detector may be implemented such that a motion mechanism that moves the cue capture device into position in response to a motion control command.

The detector may be implemented such that the motion control command is received from the second device.

The detector may be implemented such that it includes a historic value retriever that retrieves a historic wear indication for the abrasive article.

The detector may be implemented such that it includes a threshold retriever that retrieves a threshold for the efficacy generator.

The detector may be implemented such that it includes a parameter retriever that retrieves a set of operational parameters for the abrasive article. The threshold is retrieved based on the set of operational parameters.

The detector may be implemented such that the second device includes a datastore that receives and stores the wear indication.

The detector may be implemented such that the wear communicator generates a wear alarm such that second device generates an alarm based on the received detected wear cue.

The detector may be implemented such that the cue capture device includes a camera.

The detector may be implemented such that it includes an ultraviolet light source. The detector may be implemented such that it includes the camera is an infrared camera.

The detector may be implemented such that the camera images a surface of the abrasive article.

The detector may be implemented such that the camera images swarf produced by an abrasive operation.

The detector may be implemented such that the cue capture device includes a temperature sensor.

The detector may be implemented such that the temperature sensor includes a thermocouple integrated into the backup pad.

The detector may be implemented such that the cue capture device includes a scale that measures a weight of the abrasive article.

The detector may be implemented such that the cue capture device includes a calipers that measures a thickness of the abrasive article.

The detector may be implemented such that the efficacy indication generator analyzes the image for a change in color.

The detector may be implemented such that the efficacy indication generator analyzes the image for fluorescence.

The detector may be implemented such that the efficacy indication generator analyzes a shape of produced swarf.

An abrasive article with a wear cue that includes a bond matrix and a plurality of shaped abrasive particles within the bond matrix. The abrasive article also includes a detectable wear indicator that becomes detectable after a portion of the service life of the abrasive article has passed.

The abrasive article may be implemented such that the abrasive article is a bonded abrasive article. The bond matrix is a resin, polymer, or vitreous bond.

The abrasive article may be implemented such that the wear cue is a fluorescent material. The fluorescent material is revealed as the abrasive article is worn down.

The abrasive article may be implemented such that the fluorescent material is incorporated into the bond matrix.

The abrasive article may be implemented such that the wear cue is a heat activated component.

The abrasive article may be implemented such that the wear cue melts at a temperature threshold.

The abrasive article may be implemented such that the wear cue changes color at a temperature threshold.

The abrasive article may be implemented such that the heat activated component is a colored wax.

The abrasive article may be implemented such that the wax encapsulates a wear indicator.

The abrasive article may be implemented such that the wear cue is a dye.

The abrasive article may be implemented such that the wear cue, when activated, produces haze or smoke.

The abrasive article may be implemented such that the wear cue, when activated, produces a smell.

The abrasive article may be implemented such that the wear cue is an encapsulated material.

The abrasive article may be implemented such that the abrasive article includes a backing. e abrasive. The particles are coupled to the backing by the bond matrix.

The abrasive article may be implemented such that the wear cue is a fluorescent material. The fluorescent material is revealed as the abrasive article is worn down.

The abrasive article may be implemented such that the fluorescent material is incorporated into the bond matrix.

The abrasive article may be implemented such that the backing is a nonwoven backing.

A method of evaluating an abrasive article includes abrading a substrate with the abrasive article, capturing an indication of the abrasive article with a detector proximate the abrasive article, evaluating the indication, using an efficacy evaluator, against a wear threshold, and providing a wear indication if the indication is greater than the wear threshold.

The method may be implemented such that it also includes capturing an initial indication prior to a first abrading operation with the abrasive article.

The method may be implemented such that the detector includes a camera.

The method may be implemented such that the detector includes a thermometer.

The method may be implemented such that the wear threshold is selected based on the abrasive article.

The method may be implemented such that the wear threshold is selected based on a set of operational parameters for an abrasive operation.

The method may be implemented such that, if the indication is lower than the wear threshold, providing no wear indication.

The method may be implemented such that, if the indication is lower than the wear threshold, providing a remaining service life indication.

The method may be implemented such that it includes estimating a remaining service life based on the indication.

The method may be implemented such that the remaining service life indication is estimated based on historic wear trends for the abrasive article.

The method may be implemented such that the remaining service life indication is estimated based on current operational parameters.

The method may be implemented such that the remaining service life indication is based on projected operational parameters.

The method may be implemented such that, if the indication is higher than the threshold, generating an indication that the abrasive article should be treated prior to the next operation.

The method may be implemented such that, if the indication is higher than the threshold, generating a command for a robotic abrading unit to treat the abrasive article prior to the next operation.

A method of forming an abrasive article is presented that includes providing a plurality of abrasive particles, a bond matrix precursor, and a backing material. The method also includes incorporating a wear indicator into any of: the abrasive particles, the bond matrix precursor or a backing. The method also includes embedding the abrasive particles within the bond matrix precursor. The method also includes curing the bond matrix precursor to form the abrasive article. The wear indicator becomes detectable as the abrasive article is used in abrasive operations.

The method may be implemented such that the wear indicator is not detectable prior to a first abrasive operation using the abrasive article.

The method may be implemented such that the abrasive article is a bonded abrasive article. The backing material is a scrim layer.

The method may be implemented such that the backing material is a nonwoven material.

The method may be implemented such that the bond matrix precursor is a resin bond precursor, a vitreous bond precursor or a polymer bond precursor.

The method may be implemented such that the wear indicator is a fluorescent material.

The method may be implemented such that the wear indicator is a first subset of the abrasive particles. The subset of abrasive particles are a first color different from a second subset of the abrasive particles.

The method may be implemented such that the wear indicator is an encapsulated material.

The method may be implemented such that the encapsulated material includes dye.

The method may be implemented such that the encapsulated material includes a smoke or haze generating material.

The method may be implemented such that the wear indicator is a spark-generating material.

### EXAMPLES

The following materials were used in Examples Herein.

### AX55362—Polyester Backing

AX55362 is a polyester backing manufactured by 3M ASD in Alexandria, MN and its preparation is described in U.S. Pat. No. 6,843,815. The polyester backing containing fluorescent dye as purchased from Milliken and then treated with K2A presize (epoxy/acrylate/novolac resin) and calcium carbonate filled phenolic resin backsize.

### 784F 36+LH42 Coated Abrasive Belt

784F 36+ is a Cubitron™ II Y weight polyester metal working belt manufactured by 3M ASD in Alexandria, MN. The 784F 36+ Cubitron™ II belt comprises AX55362 backing, phenolic make resin, PSG and aluminum oxide mineral blend, phenolic resin size and epoxy resin supersize.

### UV Lamp

The UV lamp is a EL series 6-watt hand held lamp with 365nm wavelength output purchased from transluminators.com.

### Example 1: Swarf Collection

A coated abrasive belt (784F grade 36+, 3M Company, Saint Paul, Minnesota) of dimensions 10.16 cm by 91.44 cm was abraded against a 1.9 cm by 1.9 cm by 61 cm 304 stainless steel bar on which the surface to be abraded measured 1.9 cm by 1.9 cm. A 20.3 cm diameter 70 durometer rubber, 1:1 land to groove ratio, serrated contact wheel was used. The belt was run at 2750 rpm. The workpiece was applied to the center part of the belt at a normal force of 5.5 kg for 15 seconds. After each cycle the workpiece was cooled by dunking in water and dried. The test ran for 50 cycles. Swarf was collected during cycle 1 and imaged under a microscope. Swarf was also collected during cycle 50 and imaged under a microscope. The images are shown in FIGS. 11A and 11B.

### Example 2: Fluorescent Backing Material

The following materials were used to prepare a chemically crosslinked fibers with photochromic or thermochromic dyes. It is noteworthy to point out that this is an example of making a fiber. Many other materials can replace or even be more suitable for a particular application. This material set was chosen because the formula is practiced readily within 3M and easy to obtain for a feasibility test. A detailed description of the materials used in this invention is summarized in Table 1.

TABLE 1
Materials used in EXAMPLES 2, 2A and 2B.

| Abbreviation | Description and Source |
|---|---|
| IOA/AA | A partially cured prepolymer of 90:10 isooctyl acrylate and acrylic acid was |
| | prepared within 3M, St. Paul, MN. |
| TMPTA | Trimethylolpropane triacrylate was obtained from Alfa Aesar, Haverhill, MA |
| Irg 651 | 2,2-dimethoxy-2-phenylacetophenone based photoinitiator for radical |
| | polymerization was obtained under the trade designation of OMNIRAD 651 |
| | (the previous name was IRGACURE 651) from IGM Resins, Charlotte, NC. |
| Irg 819 | Bis(2,4,6-trimethylbenzoyl)phenylphosphineoxide photoinitiator for radical |
| | polymerization was obtained under the trade designation of OMNIRAD 819 |
| | (the previous name was IRGACURE 819) from IGM Resins, Charlotte, NC. |
| FD | 2,5-Thiophenediylbis(5-tert-butyl-1,3-benzoxazole) based fluorescent |
| | whitening agent obtained under the trade designation of Benetex ® OB Plus |
| | from Mayzo, Suwanee, GA. |

### Fiber Spinning Methods

This study used a single hole blunt needle to obtain large fiber diameter. Abrasive applications are looking for novel fibers with a fiber diameter around 40 micrometers or larger, and a blunt needle was capable of making in the several tens of micrometers to a few hundreds of micrometers in fiber diameter. A 20 mL stainless steel metal syringe was filled with the resin and placed on to a syringe pump with a Luer lock adaptor to connect an 18 gauge stainless steel blunt needle. The use of a metal syringe prevented the fluorescent lights in the lab from initiating the resin inside the barrel unintentionally. The resin dropped vertically down to the collector at the bottom of the apparatus. The current fiber spinning setup can install up to two light sources on to an 8020 frame, which can move in x, y, z-direction, and various angles. The syringe flow rate was set to 5 mL/min to obtain a continuous stream of fiber strand without breakage.

Two UVLED light sources with a peak wavelength at 365 nm and 405 nm were purchased from Phoseon, and their specs are tabulated in Table 2 below. The light intensity was controlled using the controller provided by the manufacturer. For consistency, the highest light intensity of 100% was used throughout the experiment. In order to attenuate the fibers, UVLED light was illuminated right above the collector, where the 8020 mounting frame for the light source was 30.25″ below the 8020 mounting frame for the syringe pump. Unless further noted, the 405 nm UVLED was used for fiber spinning.

TABLE 2
The specification of the UVLED light sources used in this study.

| | Peak | Peak | |
|---|---|---|---|
| Model | Wavelength | Irradiance | Emitting Size |
| FJ240 | 365 nm | 8 W/cm² | 150 mm × 40 mm |
| 150 × 40AC 365-8W | | | |
| FJ240 | 405 nm | 12 W/cm² | 150 mm × 40 mm |
| 150 × 40AC405-12W | | | |

### Comparative Example 2A

A control sample was made by mixing 100 parts of IOA/AA with 1 phr of Irg 651, 1 phr of Irg 819, and 10 phr of TMPTA. All of the material was poured into a black plastic jar and mixed using a speed mixer. The mixed resin was used after 12 hours to give enough time to get rid of bubbles generated during the mixing process. The fibers were optically transparent.

### Comparative Example 2B

0.1 phr of FD was added to the same components described in Comparative Example 2A. The material was processed the same. According to the product datasheet, FD absorbs UVA light and emits visible light, as shown on the left of FIG. 18. To examine the effectiveness of the dye, the light of the optical microscope was turned off, and then UVA dark light was illuminated onto the sample. As one can see from FIG. 18, the control fibers show only a mere reflection of the UVA light when illuminated. However, the fibers containing only a small amount of FD shined bright blue with dark light.

### Example 3

The coated abrasive belt 784F 36+ Cubitron™ II, commercially available from 3M, St. Paul, MN, was abraded with a stainless-steel metal bar (0.635 mm×0.635 mm×152 mm) to expose the backing. Next the abraded area of the belt was subjected to a UV handheld lamp, EL series 6-watt handheld lamp with 365 nm wavelength output commercially available from trasluminators.com, Atkinson, NH. The abrased area fluoresced, as shown in FIG. 8, indicated end of life of coated abrasive belt.

### Example 4

In order to study the relationship of workpiece stock removal rate and workpiece temperature, a grinding test was conducted on 10.16 cm by 91.44 cm belt converted from coated abrasive samples. A 20.3 cm diameter 70 durometer rubber, 1:1 land to groove ratio, serrated contact wheel was used. The belt was run at 2750 rpm. The workpiece was a 304 stainless steel bar having dimensions of 1.9 cm×1.9 cm×60.96 cm, on which the surface to be abraded measured 1.9 cm by 1.9 cm. The workpiece weight was recorded in grams then was forced into the center part of the belt. The test was run at 11.34 kg (25 lb). Each cycle of the test consisted of 6 seconds of grinding. At the conclusion of the 6 second grinding cycle, the workpiece end that contacted the abrasive belt was moved to an IR thermometer make and model Omega OS552-MA-6 to record workpiece temperature. The workpiece was then cooled by quenching 1.3 cm of the abraded end in 15.5° C. water for 8 seconds followed by a continuous jet of pressurized air for 10 seconds to dry the workpiece. The workpiece was then weighed to determine the amount of material removed in grams which concluded the cycle. The final workpiece weight from the previous cycle was used as the initial workpiece weight for the ensuing cycle. If the final mass of the workpiece after abrasion weighed less than 275 grams, a new 304 stainless steel bar having dimensions of 1.9 cm×1.9 cm×60.96 cm was weighed and used for the ensuing cycle. The test was concluded after 120 cycles. The workpiece removal in grams per cycle (FIG. 12A) and workpiece temperature in ° F. per cycle (FIG. 12B) were analyzed to show that when the abrasive wore down and cut less efficiently, there resulted an increased temperature buildup in the workpiece.

### Example 5

A 984F CubitronTMII belt was subjected to 60 grinding cycles removing 15 mm of the stainless-steel bar at 180N of force, which equates to 0.45N/mm2. After each cycle, all parameters were measured, but specifically the time taken to grind the substrate and the temperature after grinding. In addition, a photo of the identical piece of Abrasive was taken after every 5 cycles to show visually the condition of the belt, and specifically the amount of ‘Blue’ material generated by exposure of the PSG Abrasive grains

TABLE 3
Experimentation Inputs:

| | | | | | | | pressure | bar (mm | | |
|---|---|---|---|---|---|---|---|---|---|---|
| belt type | grain | m/s | steel | ctw | plunge (mm) | force (N) | (N/mm²) | × mm) | temp ° C. | Photos |
| 984F, | 36+ | 32 | stainless | 95 Sh A | 15 | 180 | 0.45 | 20 × 20 | | every plunge first 10 |
| TS5 | | | | | | | | | | cycles; than every 5th |
| | | | | | | | | | | plunge; end with 60 |
| | | | | | | | | | | plunges |

The experiments conducted showed very clearly that progression through the grinding cycles resulted in an increase in temperature and an increase in the amount of ‘Blue’ PSG grain that was visible on the surface of the belt.

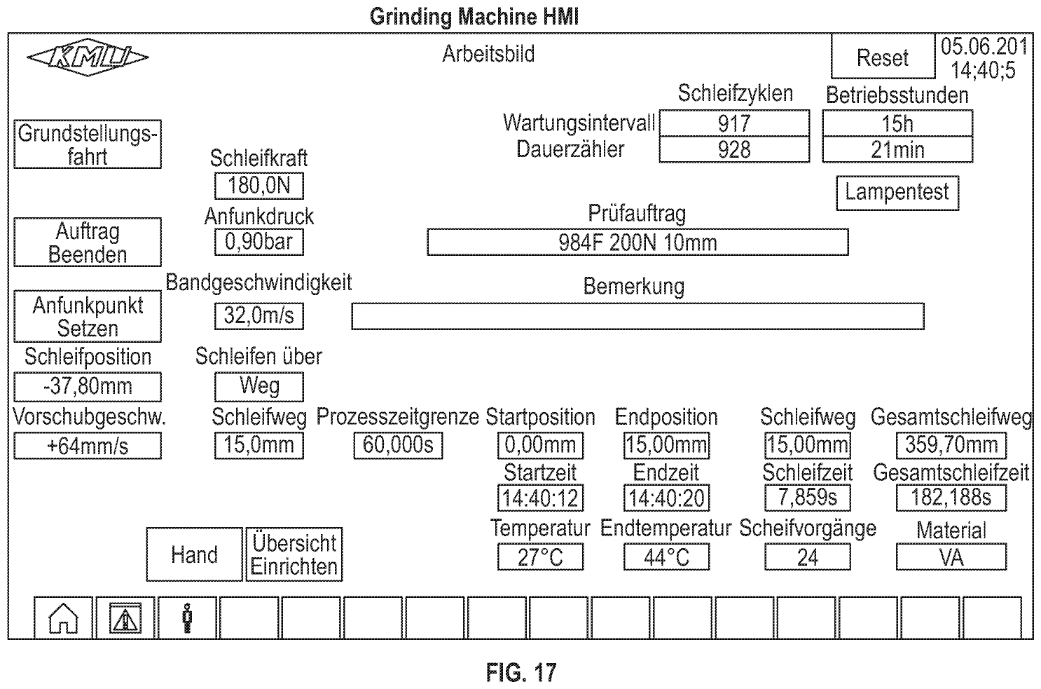

An image of the grinding machine interface which is shown in FIG. 17. The grinding machine interface in the 3M Neuss lab enables a range of process operating parameters to be modified to adjust amounts of material removal, or the speed of material removal.

The user interface allows process operating conditions to be modified, or in this case maintained to show the decay of abrasive over a series of fixed operating conditions. In this case, belt type, contact force, belt speed, and material removal amount were fixed. The automated grinding machine conducted over 60 material removal cycles on individual metal bars, where after each cycle the material removal rate (Time) substrate temperature (C), and delta belt thickness (mm) were measured and correlated to an appearance of the abrasive grains.

The increments in cycle time required to remove 15 mm of material showed the decay of the abrasive, and commensurately the increases in temperature show the cut rates to be less effective as the mineral tips start to wear. In all cases, the belt thickness changed which each cycle, indicating a loss of mineral tips and change in height of the belt topography over time when subjected to metal griding cycles.

TABLE 4
Temperature and Cut Rates

| | | | | | | | Belt | Belt | Belt | | |
|---|---|---|---|---|---|---|---|---|---|---|---|
| | | | Material | | | | Thickness | Thickness | Thickness | | |
| | Grinding | Cutting | removal | Cycle time | Endtemp | | Point 1 | Point 2 | Point 3 | Belt weight | Belt gauge |
| Cycle | Force [N] | Speed [m/s] | [mm] | [s] | [° C.] | Material | [mm] | [mm] | [mm] | [Gramm] | loss |
| 0 | 0 | 0 | 0 | 0 | 0 | MS | 1.062 | 1.072 | 1.07 | 137.6 | 137.6 |
| 1 | 100 | 31 | 20 | 15.2 | 59.2 | MS | 0.988 | 0.912 | 0.982 | 136.2 | 1.4 |
| 2 | 100 | 31 | 20 | 15.0 | 55.6 | MS | 1 | 0.898 | 0.965 | 135.4 | 2.2 |
| 3 | 100 | 31 | 20 | 15.5 | 64.2 | MS | 0.993 | 0.898 | 0.935 | 134.9 | 2.7 |
| 4 | 100 | 31 | 20 | 14.9 | 59.2 | MS | 0.959 | 0.894 | 0.932 | 133.8 | 3.8 |
| 5 | 100 | 31 | 20 | 14.6 | 56.7 | MS | 0.948 | 0.9 | 0.973 | 133.2 | 4.4 |
| 5 | 100 | 31 | 20 | 15.3 | 79.1 | MS | 0.926 | 0.878 | 0.875 | 132.3 | 5.3 |
| 7 | 100 | 31 | 19.9 | 15.6 | 61.5 | MS | 0.896 | 0.876 | 0.879 | 131.6 | 6 |
| 8 | 100 | 31 | 20 | 15.7 | 60.1 | MS | 0.914 | 0.879 | 0.873 | 130.8 | 6.8 |
| 9 | 100 | 31 | 20 | 16.2 | 63.9 | MS | 0.899 | 0.873 | 0.876 | 130.3 | 7.3 |
| 10 | 100 | 31 | 20 | 16.2 | 61.4 | MS | 0.871 | 0.86 | 0.858 | 129.8 | 7.8 |

1. An abrasive article evaluation system comprising:
a detector that detects an abrasive wear cue;
an efficiency indication generator that, based on the abrasive wear cue, generates an indication of wear for the abrasive article; and
a command generator that generates a command based in the generated indication of wear, wherein the command is a downstream operation command that, based on the indication of wear, adjusts a downstream abrading operation parameter.

2. The system of claim 1, further comprising:
a parameter retriever that retrieves a current operational parameter for a tool associated with the abrasive article; and
wherein the command generator generates a command to adjust the operational parameter from a first value to a second value, different from the first value.

3. The system of claim 2, wherein the operational parameter is an applied force, the tool is a robotic abrading unit and the second value is a higher applied force than a first applied force.

4. The system of claim 2, wherein the operation parameter is a speed, and wherein a second speed is higher than a first speed.

5. The system of claim 1, wherein the operation parameter is an angle and wherein a second angle is different from a first angle.

6. (canceled)

7. (canceled)

8. The system of claim 7, wherein the detector comprises a cue capture device.

9. The system of claim 8, wherein the cue capture device is a camera,

10. The system of claim 8, wherein the cue capture device is a temperature measuring device.

11. The system of claim 10, wherein the temperature measuring device comprises a thermocouple incorporated into a backup pad,

12. The system of claim 10, wherein the temperature measuring device comprises an infrared camera.

13. The system of claim 8, wherein the cue capture device is a scale, and wherein the cue is a weight of the abrasive article.

14. The system of claim 8, wherein the cue capture device is a calipers and wherein the cue is a thickness of the abrasive article

15. The system of claim 8, and wherein the detector comprises a movement mechanism and a movement controller that moves the detector into position.

16. The system of claim 8, wherein the detector comprises a light source.

17. The system of claim 1, wherein the wear cue is a spark, and wherein the cue capture device captures an increase or change in sparking

18. A robotic abrading system comprising:
an abrasive article comprising a wear cue;
a backup pad coupled to the abrasive article;
a robot arm configured to move the abrasive article into position with respect to a substrate;
a force control unit, on the robot arm and coupled to the backup pad, wherein the force control unit applies a force to the backup pad; and
a wear indication system that determines an amount of wear of the abrasive article based on the wear cue, and, based on the amount of wear, an operational parameter of the robotic abrading system is adjusted,
wherein the wear indication system comprises:
a detector that detects the wear cue;
an efficiency indication generator that generates an abrasive efficiency for the abrasive article; and
a command generator that generates a command to adjust the operational parameter.

19. (canceled)

20. The robotic abrading system of claim 19, wherein the detector comprises an ultraviolet light source, the wear cue is a fluorescent material on the abrasive article, and the generated abrasive efficiency is based on a detected area of the fluorescent material.

21. The robotic abrading system of claim 19, wherein the wear cue is a heat activated material that changes color at a temperature threshold, and wherein the detector comprises a camera.

22. The robotic abrading system of claim 19, wherein the wear cue is an operational temperature and wherein the detector comprises a temperature sensor.

23. The robotic abrading system of claim 22, wherein the detector comprises a scale and wherein the robotic arm provides the abrasive article to the scale in between abrasive operations.

24. The robotic abrading system of claim 22, wherein the detector comprises the force control unit, and wherein the force control unit detects a change in weight of the abrasive article.

25. The robotic abrading system of claim 22, wherein the detector comprises a calipers, and wherein the robotic arm provides the abrasive article to the calipers in between abrasive operations.

26. The robotic abrading system of claim 22, wherein the detector comprises a camera that images the abrasive article.

27. The robotic abrading system of claim 26, wherein the camera images a surface of he abrasive article.

28. The robotic abrading system of claim 26, wherein an image from the camera is analyzed by the efficiency indication generator and a visual indication of wear is detected.

29. The robotic abrading system of claim 28, wherein the visual indication is a change in color, a message, a haze, or a smoke.

30. The robotic abrading system of claim 19, wherein the detector comprises a camera that images swarf produced during the abrasive operation.

31. The robotic abrading system of claim 18, wherein the operational parameter is an automatic shutdown.

32. The robotic abrading system of claim 18, wherein the operational parameter is an applied force by the force control unit, a rotational speed of the abrasive article, or a dwell time of the abrasive article on the substrate.

33. (canceled)

34. (canceled)

35. (canceled)

36. (canceled)

37. (canceled)

38. (canceled)

39. (canceled)

40. (canceled)
